(19) United States
(12) Patent Application Publication
(10) Pub. No.: US 2026/0244123 A1
(43) Pub. Date: Aug. 20, 2026

(54) TWO-COMPONENT DEVELOPER

(71) Applicant: CANON KABUSHIKI KAISHA, Tokyo (JP)

(72) Inventors: TORU TAKAHASHI, Ibaraki (JP); ICHIRO KANNO, Chiba (JP); YUU NISHIMURA, Chiba (JP); KOHEI YOSHIYAMA, Chiba (JP); MIZUKI SAITO, Chiba (JP); KENTARO KAMAE, Kanagawa (JP); NOBUHIRO YOSHIDA, Ibaraki (JP); TAKAHO SHIBATA, Tokyo (JP)

(21) Appl. No.: 19/536,331

(22) Filed: Feb. 11, 2026

(30) Foreign Application Priority Data
Feb. 18, 2025 (JP) 2025-023954

(51) Int. Cl. G03G 9/08; G03G 9/087; G03G 9/097

(52) U.S. Cl. CPC G03G 9/0819; G03G 9/0821; G03G 9/08795; G03G 9/09733

(57) ABSTRACT

A two-component developer containing a toner and a magnetic carrier, the toner containing a toner particle; the toner particle containing: a binder resin; and a resin bearing an oxazoline group at a surface of the toner particle, the magnetic carrier containing: a magnetic carrier core particle; and a resin coat layer formed on a surface of the magnetic carrier core particle, the resin coat layer containing: a silicone resin; and a barium titanate particle, wherein a content of the barium titanate particle in the resin coat layer is 2 to 32 mass %, based on a mass of the resin coat layer, and a value (Ti/Ba) of a ratio of an abundance ratio (atomic %) of titanium elements to an abundance ratio (atomic %) of barium elements, as determined by X-ray photoelectron spectroscopy of a surface of the magnetic carrier, is 2.0 to 20.0.

### BACKGROUND

### Field of the Technology

The present disclosure relates to a two-component developer used for an electrophotographic system, an electrostatic recording system, and an electrostatic printing system.

### Description of the Related Art

In recent years, full-color copiers of an electrophotographic system are used widely, and application thereof in the printing market has begun. In the printing market, higher image quality and higher stability, such as dot reproducibility to faithfully develop a latent image, are required as the printing speed increases.

In order to achieve high image quality, it is necessary to stabilize the charging characteristics of the two-component developer. For the charging characteristics of the two-component developer, the charging characteristics of the toner and the carrier need to be controlled separately.

The charging characteristics of the toner are generally controlled by an external additive. However, as speed increases, the load on the toner from the carrier tends to increase. As a result, external additives become embedded in the toner, particularly in a high-temperature, high-humidity environment, increasing the likelihood that the charging characteristics of the toner change over a long period of use. In particular, when the charging characteristics of the external additive and the toner particle are greatly different from each other, the charge quantity distribution is likely to become broad.

Accordingly, various studies have been conducted on imparting a charge-controlling function to the toner particle, in addition to an external additive.

For example, Japanese Patent Laid-Open No. 2019-128434 discloses a toner including a resin bearing an oxazoline group as a shell layer in order to achieve both low-temperature fixability and heat-resistant storability, while improving the charging characteristics of the toner.

Further, Japanese Patent Laid-Open No. 2023-14693 discloses a carrier that improves charge-imparting abilities to a toner by incorporating barium titanate particles, which are ferroelectric, into the carrier coat layer in order to improve the charging characteristics of the carrier.

### SUMMARY

However, when the external additives become embedded in the toner due to a long period of use, non-electrostatic attachment force between the toner and the carrier becomes high.

Since the functional group that has a charge-control function, as disclosed in Japanese Patent Laid-Open No. 2019-128434, has high polarity, the non-electrostatic attachment force tends to become particularly high. Moreover, it has been found that when the charge quantity is high, the electrostatic attachment force is also high, resulting in a marked decrease in the flowability of the two-component developer and the formation of a streak-like image defect on the image.

Meanwhile, in a case where the charging characteristics of the carrier are improved, when a toner with embedded external additives, which have been used for a long period of time, mixes with a newly replenished toner, significant changes occur in the charging characteristics of the toner. Thus, it has been found that the charge quantity distribution may become broader, and dot reproducibility may be reduced in some cases.

Therefore, it has been found that further improvement is necessary to suppress image streaks caused by the reduced flowability of a two-component developer and to improve dot reproducibility over a long period of time, even under a high-temperature, high-humidity environment.

The present disclosure relates to a two-component developer comprising a toner and a magnetic carrier, the toner comprising a toner particle; the toner particle comprising: a binder resin; and a resin bearing an oxazoline group at a surface of the toner particle, the magnetic carrier comprising: a magnetic carrier core particle; and a resin coat layer formed on a surface of the magnetic carrier core particle, the resin coat layer comprising: a silicone resin; and a barium titanate particle, wherein a content of the barium titanate particle in the resin coat layer is 2 to 32 mass %, based on a mass of the resin coat layer, and a value (Ti/Ba) of a ratio of an abundance ratio (atomic %) of titanium elements to an abundance ratio (atomic %) of barium elements, as determined by X-ray photoelectron spectroscopy of a surface of the magnetic carrier, is 2.0 to 20.0.

Features of the present disclosure will become apparent from the following description of embodiments. The following description of embodiments is described by way of example.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ.

The two-component developer according to the present disclosure contains a resin bearing an oxazoline group at the surface of the toner particle.

In order to improve the charging characteristics of the toner, it is effective to have the toner particle contain a resin bearing an oxazoline group at the particle surface. As a result, a high charge quantity and a sharp charge quantity distribution can be achieved even in a toner with external additives embedded due to long-term use.

Meanwhile, the toner with embedded external additives exhibits a high attachment force. In particular, a toner particle containing a resin bearing an oxazoline group at the particle surface provides a toner with a highly polar surface, thereby increasing attachment force. For this reason, the carrier carries the toner, and the external additive becomes embedded in the toner, thereby increasing the attachment force. As a result, the flowability of the developer decreases, leading to the formation of image streaks.

As a result of intensive studies on a configuration in which the toner is appropriately consumed during the developing step while maintaining a high charge quantity, the present inventors have found that the dot reproducibility can be improved as well as the suppression of image streaks by the configuration of a two-component developer containing a toner and a magnetic carrier, the toner containing a toner particle; the toner particle containing a binder resin and a resin bearing an oxazoline group at the surface of the toner particle, the magnetic carrier including a magnetic carrier core particle and a resin coat layer formed on the surface of the magnetic carrier core particle, the resin coat layer including a silicone resin; and barium titanate particles, the two-component developer having a barium titanate particle content in the resin coat layer of 2 to 32 mass % based on the mass of the resin coat layer, and the magnetic carrier having a value (Ti/Ba) of the ratio of the abundance ratio (atomic %) of titanium elements to the abundance ratio (atomic %) of barium elements of 2.0 to 20.0 in the elemental analysis of the surface of the magnetic carrier using X-ray photoelectron spectroscopy.

The inventors of the present invention believe the reason why the above configuration achieves the effects of the present disclosure is as follows.

Barium titanate particles are known as ferroelectric particles. A ferroelectric is a material that is polarized by an external electric field.

The two-component developer is placed in a developing electric field in order to develop a toner from the carrier to the photosensitive member during the developing step. At this time, the barium titanate particles are polarized in accordance with a developing electric field. The barium titanate particles in the developing electric field are polarized in the direction where electrostatic repulsion between the barium titanate particles and the toner occurs. However, when the barium titanate particles are merely polarized in a dispersed state in the resin coat layer, the electrostatic repulsion force cannot be effectively obtained because the barium titanate particles are not in direct contact with the toner.

Due to the chemical structure of the barium titanate particles (BaTiO3), the value (Ti/Ba) of the ratio of the abundance ratio (atomic %) of titanium elements to the abundance ratio (atomic %) of barium elements in elemental analysis of the surface by X-ray photoelectron spectroscopy takes a value of about 1.0.

A magnetic carrier in the two-component developer of the present disclosure is characterized in that, in elemental analysis of a surface of the magnetic carrier by X-ray photoelectron spectroscopy, the value (Ti/Ba) of the ratio of the abundance ratio (atomic %) of titanium elements to the abundance ratio (atomic %) of barium elements is from 2.0 to 20.0.

This shows that the resin coat layer (for example, in a silicone resin contained in the resin coat layer) contains titanium elements independently of the barium titanate particles.

It is believed that titanium elements present in the resin coat layer function as polarization sites of the resin coat layer. Due to the presence of titanium elements at the surface, electrostatic repulsion caused by polarization of the barium titanate particles present in the resin coat layer can be transmitted to the carrier particle surfaces with which the toner is in contact.

The present inventors have found that the toner can be appropriately consumed during development by combining the toner bearing an oxazoline group with the magnetic carrier as described above because such a toner has a high attachment force and a high charge quantity, thereby effectively receiving the electrostatic repulsion force from the carrier.

It is considered that as a result, a marked decrease in the flowability of the two-component developer is suppressed, image streaks are suppressed, and development with a high charge quantity is possible, and thus, the improvement in dot reproducibility can be achieved.

In the two-component developer according to the present disclosure, the content of barium titanate particles contained in the resin coat layer is 2 to 32 mass % on the basis of the mass of the resin coat layer.

When the content of the barium titanate particles is within the above range, the effect of electrostatic repulsion due to polarization and the ability to impart charges to the toner can be obtained effectively, and the dot reproducibility can be improved while suppressing image streaks.

The barium titanate particle content is preferably 4 to 28 mass % and more preferably 10 to 20 mass %.

The magnetic carrier has a value (Ti/Ba) of the ratio of the abundance ratio (atomic %) of titanium elements to the abundance ratio (atomic %) of barium elements of preferably 5.0 to 18.0, and more preferably 6.0 to 15.0, in the surface analysis of the magnetic carrier using X-ray photoelectron spectroscopy in order to achieve the above effect.

The barium titanate particle content and the above value of the ratio can be adjusted, as appropriate, for example, based on the amounts of the titanium compound and barium titanate particles to be added to the coat resin solution to be coated onto the magnetic carrier core particle.

Furthermore, a value of the ratio within the above range can be achieved by controlling the proportion of barium titanate particles present in the surface layer of the magnetic carrier, while the resin coat layer partially includes the barium titanate particles.

For example, the value of the ratio can be controlled within the above range by adjusting the amount of the coating resin and forming a coating resin of a thickness that can partially enclose the barium titanate particles according to the particle diameter of the barium titanate particles.

In addition, the resin coat layer may have a multi-layer structure by a method such as forming a resin coat layer containing barium titanate particles and then forming a resin coat layer not containing barium titanate particles.

### Measurement Method of Barium Titanate Particle Content

The barium titanate particle content in the resin coat layer is measured by the following method.

First, a silicone resin in a resin coat layer is sufficiently dissolved from the magnetic carrier using a silicone dissolving agent (for example, silicone cleaner X-300 manufactured by Nissin Kagaku Kenkyusho Co., Ltd.).

The resin coat layer is removed by filtering the obtained solution. The mass of the residue obtained by filtration is subtracted from the mass of the magnetic carrier, thereby determining the mass of the resin coat layer.

The solution is then centrifuged to separate the barium titanate particles contained in the resin coat layer. After the separated barium titanate particles are filtered, washed, and dried, the mass is weighed, and a value obtained by dividing the mass of the dried barium titanate particles by the mass of the resin coat layer is assumed as the content of barium titanate particles to be included in the resin coat layer.

The titanium source, when the titanium element is incorporated into the resin coat layer separately from the barium titanate particles, is not particularly limited, but titanium elements derived from organic titanium compounds are preferred.

By forming a resin coat layer using a silicone resin containing an organic titanium compound, titanium elements can be uniformly distributed in the resin coat layer, and the effect due to polarization can be effectively achieved.

Examples of organic titanium compounds may include the following compounds: tetrabutyl titanate, tetraoctyl titanate, isopropyl tri-isostearoyl titanate, isopropyl tridecyl benzenesulfonyl titanate, bis(dioctyl pyrophosphate)oxyacetate titanate, diisopropoxy titanium bis(acetylacetonate), titanium tetra(acetylacetonate), dioctanoxy titanium dioctanate, diisopropoxy titanium bis(ethylacetoacetate), and diisopropoxy titanium bis(triethanolaminate).

### Silicone Resin

The resin coat layer contains a silicone resin.

The inclusion of a silicone resin in the resin coat layer imparts high charge-providing ability to the toner bearing an oxazoline group at the toner particle surface and suppresses non-electrostatic attachment forces between the toner and the carrier, allowing for proper toner consumption during development. As a result, a marked decrease in the flowability of the two-component developer is suppressed, image streaks are suppressed, and development of a toner with a high charge quantity is possible, thereby improving dot reproducibility.

Examples of silicone resins may include a methylsilicone resin, a methylphenylsilicone resin, and an epoxy resin-modified silicone resin, with methylphenylsilicone resin being preferred.

Also, the amount of the coating resin of the silicone resin relative to 100 parts of the magnetic carrier core particle is preferably 0.8 to 2.5 parts, and more preferably 1.5 to 2.5 parts.

The resin coat layer does not necessarily cover the entire magnetic carrier core particle surface, and some part of the magnetic carrier core particle may be exposed. That is, the resin coat layer covers at least a part of the surface of the magnetic carrier core particle.

As the magnetic carrier core particle, an ordinary magnetic carrier core particle, such as ferrite and magnetite, may be used. Also, a binder-type magnetic carrier core particle in which magnetic powder is dispersed in a resin may be used. It is also possible to use a magnetic core in which a resin is filled in porous ferrite or magnetite particles.

Specific examples of ferrite raw materials, which are raw materials for the magnetic carrier core particle, may include a composition containing at least one selected from the group consisting of Fe₂O₃, MnCO₃, MgFe₂O₄, and ZrO₂.

The Fe₂O₃ content in the ferrite raw material is preferably 40 to 80 mass % and more preferably 50 to 70 mass %.

The MnCO₃ content in the ferrite raw material is preferably 10 to 40 mass % and more preferably 15 to 30 mass %.

The MgFe₂O₄ content in the ferrite raw material is preferably 10 to 30 mass % and more preferably 15 to 20 mass %.

The ZrO₂ content in the ferrite raw material is preferably 0.01 to 1.2 mass %, more preferably 0.1 to 1.2 mass %, and still more preferably 0.6 to 1.0 mass %.

The same applies to the preferred composition range of the magnetic carrier core particle after firing the ferrite raw material.

The proportion of zirconium oxide (ZrO₂) is preferably 0.01 to 1.0 mass %, more preferably 0.1 to 0.8 mass %, and still more preferably 0.4 to 0.8 mass % when the total amount of all oxides is taken as 100 mass % based on the assumption that all elements detected in the fluorescent X-ray analysis of the magnetic carrier are oxides.

In the calculation, zirconium oxide is regarded as an oxide of a tetravalent metal (ZrO₂).

That is, the magnetic carrier contains zirconium elements in an amount of preferably 0.01 to 1.0 mass %, more preferably 0.1 to 0.8 mass %, and still more preferably 0.4 to 0.8 mass %, as zirconium oxide equivalents.

The method of incorporating zirconium elements into the magnetic carrier is not particularly limited, and known materials may be selected and used. Specifically, ZrO₂ or the like may be used as a raw material for the magnetic carrier core particle.

The zirconium element content in the magnetic carrier can be measured by removing the resin coat layer, followed by the fluorescent X-ray analysis described below.

The presence of zirconium elements in the magnetic carrier core particle can average out variations in grain diameter within each metal crystal that constitutes the magnetic carrier core particle and suppress the difference between protrusions and recesses on the surface of the magnetic carrier core particle.

That is, the inclusion of zirconium elements in the magnetic carrier within the above range enables barium titanate particles to be uniformly distributed on the magnetic carrier particle surfaces without being localized in the recesses of the magnetic carrier, effectively exhibiting the electrostatic repulsion force between the toner and the carrier. As a result, good dot reproducibility is attained while suppressing image streaks.

From the same viewpoint, when the zirconium element content as zirconium oxide equivalents in X-ray fluorescence analysis of the magnetic carrier is taken as X mass %, and the barium titanate particle content based on the mass of the resin coat layer is taken as Y mass %, it is preferable that the value of X x Y is from 0.4 to 23 for achieving the above effect, and is more preferably from 4 to 8.

### X-Ray Fluorescence Analysis

The X-ray fluorescence analysis of the magnetic carrier is performed by directly measuring the elements from Na to U in the order of atomic numbers in the magnetic carrier under a He atmosphere using a wavelength-dispersive X-ray fluorescence analyzer, Axios advanced (manufactured by Spectris). Using a cup for a liquid sample bundled with the apparatus, a PP (polypropylene) film is laminated to the bottom surface of the cup, a sufficient amount of the sample is placed in the cup, a uniform-thickness layer is formed on the bottom surface, and a lid is placed on the cup. The measurement is performed at a 2.4 kW output. The fundamental parameter (FP) method is used for analysis. At that time, all detected elements are assumed to be oxides, and the total mass thereof is taken as 100 mass %. The zirconium oxide (ZrO₂) content (mass %) relative to the total mass is determined as an oxide equivalent value using software, UniQuant5 (ver. 5.49) (manufactured by Spectris).

The magnetic carriers has a proportion of the barium elements based on the total content of carbon, nitrogen, oxygen, fluorine, aluminum, silicon, titanium, manganese, iron, strontium, tin, and barium of preferably 0.01 to 0.10 atomic %, more preferably 0.02 to 0.08 atomic %, and still more preferably 0.03 to 0.06 atomic % in an elemental analysis of the magnetic carrier particle surfaces using X-ray photoelectron spectroscopy.

When the proportion of barium elements on the magnetic carrier particle surfaces is within the above range, stable coating state by the resin coat layer can be achieved, and the electrostatic repulsion force between the toner and the carrier can be effectively provided, suppressing image streaks and achieving good dot reproducibility.

The above value can be adjusted, as appropriate, according to the amount of barium titanate particles to be added to the coating resin solution, for example.

Furthermore, the value can be within the above range by controlling the proportion of barium titanate particles present in the magnetic carrier particle surface layer, while the resin coat layer partially encloses barium titanate particles.

For example, the value can be controlled within the above range by adjusting the amount of the coating resin and forming a coating resin of a thickness that can partially enclose the barium titanate particles according to the particle diameter of the barium titanate particles.

In addition, the resin coat layer may have a multi-layer structure by a method such as forming a resin coat layer containing barium titanate particles and then forming a resin coat layer not containing barium titanate particles.

### Elemental Analysis Method of Magnetic Carrier by X-ray Photoelectron Spectroscopy

The elemental analysis of the magnetic carrier is performed on the basis of the measurement using X-ray photoelectric spectrophotometry (XPS) in the following manner. As the measurement sample, a magnetic carrier is placed in a sample-setting hole with a diameter of 2 mm and a depth of 2 mm, formed on a platen dedicated to XPS. Then, an X-ray irradiation portion and a sputtering portion by GCIB irradiation are set in the sample-setting hole by the XPS apparatus described below.
Apparatus used: PHI 5000 VersaProbe II manufactured by ULVAC-PHI, Inc.
Radiation: Al-Kα rays
Beam diameter: 100 μm
Output: 25 W, 15 kV
Photoelectronic uptake angle: 45° Pass Energy: 58.70 eV
Step size: 0.125 eV
XPS Peak: C1s, N1s, O1s, F1s, A12p, Si2p, Ti2p, Mn2p3, Fe2p3, Sr3d, Sn3d5, Ba3d5
Measurement range: 300 μm×200 μm

The barium titanate particles have a number-average particle diameter of the primary particles of preferably 100 to 500 nm, more preferably 200 to 400 nm, and still more preferably 300 to 400 nm.

The number-average particle diameter of the primary particles of barium titanate particles within the above range can achieve a stable coating state with the resin coat layer and effectively provide the electrostatic repulsion force between the toner and the carrier, suppressing image streaks and achieving good dot reproducibility.

### Measurement Method of Number-Average Particle Diameter of Primary Particles of Barium Titanate Particles

The number-average particle diameter of primary particles of barium titanate particles is measured using a scanning electron microscope “S-4800” (product name; manufactured by Hitachi, Ltd.). A magnetic carrier is observed, and the major diameters of 100 barium titanate particles are randomly measured in a field of view enlarged to 200000 times at maximum at an accelerating voltage of 12 kV, to determine the number-average particle diameter. The magnification of the observation is adjusted, as appropriate, based on the size of the barium titanate particles.

The distinction of the barium titanate particles is made by element mapping using Scanning Electron Microscopy-Energy Dispersive X-Ray Analyzer (SEM-EDX).

Since a stable coat state can be achieved by the resin coat layer, the volume-average particle diameter (D50) of the magnetic carrier core particle is preferably 20.0 to 80.0 μm.

### Measurement Method of Volume-Average Particle Diameter (D50) of Magnetic Carrier Core Particle

The volume-average particle diameter of the magnetic carrier core particle is measured using a laser diffraction/scattering particle size distribution measuring apparatus, “Microtrac MT 3300EX” (manufactured by Nikkiso Co., Ltd.).

The volume-average particle diameter (D50) of the magnetic carrier core particle is measured, mounting a sample supplier for dry measurement, “one-shot dry type sample conditioner, Turbotrac” (manufactured by Nikkiso Co., Ltd.). As the supply conditions of Turbotrac, a dust collector is used as the vacuum source, and the air volume is set to about 33 L/sec, and the pressure is set to about 17 kPa. Control is performed automatically via software. A 50% particle size (D50), which is a cumulative value on a volume basis, is determined as the particle diameter. The control and analysis are performed using the bundled software (version 10.3.3-202D). Measurement conditions are as follows.
SetZero Time: 10 seconds
Measurement time: 10 seconds
Number of measurements: once
Particle refractive index: 1.81%
Particle shape: non-spherical
Upper measurement limit: 1408 μm
Lower measurement limit: 0.243 μm
Measurement environment: 23° C., 50% RH
Magnetic Carrier

As the magnetic carrier, an ordinary magnetic carrier, such as ferrite or magnetite, or a resin-coated carrier may be used. Also, magnetic body-dispersed resin particles in which magnetic body powder is dispersed in a resin component, or porous magnetic core particles in which a resin is contained in the void portions may be used.

Examples of magnetic bodies used in the magnetic body-dispersed resin particles may include various magnetic iron compound particle powder, such as magnetite particle powder, maghemite particle powder, or magnetite or maghemite particle powder containing at least one selected from silicon oxide, silicon hydroxide, aluminum oxide, and aluminum hydroxide; magnetoplumbite-type ferrite particle powder containing barium, strontium, or barium-strontium; and spinel-type ferrite particle powder containing at least one selected from manganese, nickel, zinc, lithium, and magnesium.

In addition to the magnetic body components, non-magnetic iron oxide particle powder, such as hematite particle powder, non-magnetic hydrated ferric oxide particle powder, such as goethite particle powder, and non-magnetic inorganic compound particle powder, such as titanium oxide particle powder, silica particle powder, talc particle powder, alumina particle powder, barium sulfate particle powder, barium carbonate particle powder, cadmium yellow particle powder, calcium carbonate particle powder, and zinc white particle powder may be used in combination with the magnetic iron compound particle powder.

Examples of materials for porous magnetic core particles may include magnetite and ferrite. Specific examples of ferrite are represented by the following general formula.

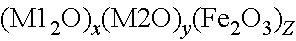

In the above formula, M1 is a monovalent metal, M2 is a divalent metal, and when x+y+z=1.0, x and y are represented by 0≤(x, y)≤0.8, respectively, and z is 0.2<z<1.0.

In the formula, at least one metal atom selected from the group consisting of Li, Fe, Mn, Mg, Sr, Cu, Zn, and Ca are preferably used as M1 and M2. Other elements, such as Ni, Co, Ba, Y, V, Bi, In, Ta, Zr, B, Mo, Na, Sn, Ti, Cr, Al, Si, rare earth metal, and the like, may also be used.

The production method of the magnetic carrier is not particularly limited, and known methods may be employed. For example, a method in which the coating resin solution is sprayed while suspending and flowing the magnetic carrier core particle to form a resin coat layer on the magnetic carrier core particle surface, and a spray-drying method may be mentioned.

When the fluidized bed coating apparatus is used, the fluidized bed formation state and the spray form of the resin solution in which the coating resin is dissolved are especially important. As for the formation state of the fluidized bed, a method in which a rotating bottom plate disk and a stirring blade are provided within the fluidized bed, and coating is performed while forming a swirling flow in order to prevent aggregation of the magnetic carrier core particle and efficiently form a coat layer may be mentioned.

Specifically, a preferred method of producing a magnetic carrier includes (1) forming the fluidized bed by an ascending gas flow in a cylindrical tube, (2) supplying the coating resin solution from a direction perpendicular to the moving direction of the fluidized bed, and (3) spray-coating the coating resin solution at a spraying pressure of 1.5 kg/cm² or more.

The specific configuration of the toner according to the present disclosure will be described below.

The toner according to the present disclosure contains a toner particle, and the toner particle is characterized by containing a binder resin, and a resin bearing an oxazoline group at the surface of the toner particle.

An oxazoline group is a functional group with high positive charge performance. The inclusion of a resin bearing an oxazoline group at the toner particle surface enables the toner to impart a high positive charging performance even when external additives are embedded, resulting in good dot reproducibility.

The resin bearing an oxazoline group is preferably a resin having units derived from 2-vinyl-2-oxazoline, 2-isopropenyl-2-oxazoline, or 2-(pent-4-ynyl)-2-oxazoline.

The monomer used in the resin bearing an oxazoline group may include a vinyl-based monomer in addition to the monomers mentioned above.

Commercially available resins bearing an oxazoline group may be used. For example, “EPOCROS (registered trademark) WS-300”, “EPOCROS (registered trademark) WS-500”, manufactured by Nippon Shokubai Co., Ltd., “EPOCROS (registered trademark) WS-700”, manufactured by Nippon Shokubai Co., Ltd., and the like may be used.

The toner has a content ratio of oxazoline groups measured by pyrolysis-gas chromatograph/mass spectrometry of preferably 0.1 to 1500 μmol/g, more preferably 0.2 to 100 μmol/g, and more preferably 20 to 50 μmol/g.

The above content ratio indicates the amount of oxazoline groups in 1 g of the toner. A content ratio of oxazoline groups in the toner within the above range enables the two-component developer of the present disclosure, when combined with the magnetic carrier of the present disclosure, to maintain a high charge quantity of the toner, thereby improving dot reproducibility.

The above content ratio can be adjusted, as appropriate, based on the amount of resin added during the step of adding a resin bearing an oxazoline group in the production method of the toner described below.

When the content ratio of oxazoline groups in a toner measured by the pyrolysis-gas chromatograph/mass spectrometry is taken as A (umol/g), and the proportion of barium elements at the surface of the magnetic carrier measured by the X-ray photoelectron spectroscopy is taken as B (atomic %), the value (B/A) of the ratio of B to A is preferably 0.001 or greater. When the value (B/A) of the ratio is 0.001 or greater, the toner bearing an oxazoline group can be consumed more effectively during the developing step. (B/A) is preferably 0.001 to 0.500 and more preferably 0.002 to 0.300.

### Measurement Method of Content Ratio of Oxazoline Groups in Toner

The oxazoline group content ratio in the toner is measured under the following conditions using a pyrolysis GC/MS apparatus. For the obtained peak area, the content ratio is quantified on the basis of a calibration curve prepared using a standard substance. A toner is used as the sample, and 2-ethyl-2-oxazoline is used as the standard substance.
Measurement instrument: “Voyager” (trade name, manufactured by Thermo Electron Corporation
Pyrolysis temperature: 600° C.
Column: HP-1 (15 m×0.25 mm×0.25 μm)
Inlet: 320° C., Split: 20.0
Injection amount: 1.0 mL/min
Heating: 40° C. (3 min) to 300° C. (10° C./min)

A resin having a structure represented by formula (1) below or a structure represented by formula (2) below exists at the surface of the toner particle; and in an FT-IR spectrum of the toner particle measured using an ATR method on a condition that Ge is used as ATR crystals and an Infrared light incidence angle is set to 45°, a peak derived from an amide bond included in the structure represented by formula (1) or the structure represented by formula (2) and a peak derived from the oxazoline group are present; and the value (Y/X) of the ratio of the intensity (Y) of a peak derived from the oxazoline group to the intensity (X) of a peak derived from the amide bond is preferably 0.15 to 0.25 and more preferably 0.18 to 0.21.

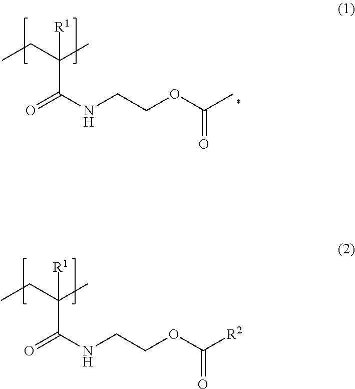

In Formula (1), R¹ represents a hydrogen atom or an alkyl group which optionally has a substituent. * connects with a binder resin.

In formula (2), R¹ represents a hydrogen atom or an alkyl group which optionally has a substituent. R² represents an alkyl group having from 1 to 3 carbon atoms.

An oxazoline group in the present disclosure opens a ring upon reaction with an acid or an acid group and has a structure of formula (1) or formula (2).

The formula (1) shows a form after a reaction with a carboxy group in the binder resin when the binder resin has a carboxy group.

The formula (2) shows a form after a reaction with an acid when the acid is added as a ring-opening agent during the production of the toner.

That is, the value (Y/X) of the ratio indicates a value of the ratio of unopened oxazoline groups to opened oxazoline group at the surface of the toner particle.

By controlling the value (Y/X) of the ratio within the above range, oxazoline groups exist properly at the surface of the toner particle, and the attachment force of the toner to the carrier and the charge quantity can be controlled, resulting in the suppression of image streaks.

The above value of the ratio can be adjusted, as appropriate, based on the acid value of the binder resin, the amount of an acid to be added as a ring-opening agent, the amount of the resin bearing an oxazoline group to be added, and the like.

Calculation Method of Value (Y/X) of Ratio of Intensity (Y) of Peak Derived from Oxazoline Group to Intensity (X) of Peak Derived from Amide Bond

A FT-IR spectrum is measured by an ATR method using a Fourier transform infrared spectrometer (Spectrum One: manufactured by PerkinElmer, Inc.) equipped with a universal ATR measurement accessory (UniversalATR Sampling Accessory). A specific measurement procedure is as follows.

The incident angle of infrared light (2=5 μm) is set to 45°. As ATR crystals, ATR crystals of Ge (refractive index=4.0) are used. Other conditions are as follows.

### Range

Start: 4000 cm⁻¹
End: 600 cm⁻¹ (Ge ATR crystals)

### Duration

Scan number: 16
Resolution: 4.00 cm⁻¹
Advanced: with CO₂/H₂O correction
Measurement Procedure
(1) Ge ATR crystal (refractive index=4.0) is attached to the apparatus.
(2) Scan type is set to Background, Units are set to EGY, and the background is measured.
(3) Scan type is set to Sample, and Units are set to A.
(4) 0.01 g of a toner particle is weighed exactly on the ATR crystals.
(5) The sample is pressurized with a pressure arm (Force Gauge is 90).
(6) The sample is measured.
(7) The FT-IR spectrum obtained is subjected to baseline correction by Automatic Correction.

### Analysis

(1) The maximum value (X) of the absorption peak (amide bond) intensity at 1630 cm⁻¹ is calculated.
(2) The maximum value (Y) of the absorption peak (oxazoline group) intensity at 1680 cm⁻¹ is calculated.

### Binder Resin

The toner particle contains a binder resin. The binder resin is not particularly limited, and a known binder resin may be used.

The binder resin preferably contains a polyester resin having an acid value from the perspective of retaining a resin bearing an oxazoline group uniformly at the surface of the toner particle.

The binder resin preferably contains an amorphous polyester resin, and is more preferably an amorphous polyester resin. A normal polyester resin constituted by an alcohol component and an acid component may be used as the polyester resin, and examples of both components are listed below.

Examples of alcohol components may include ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, cyclohexanedimethanol, butenediol, octenediol, cyclohexenedimethanol, hydrogenated bisphenol A, and a bisphenol derivative represented by the following formula (3).

Bisphenols, such as hydrogenated bisphenol A and the bisphenol derivative represented by the following formula (3) are preferred.

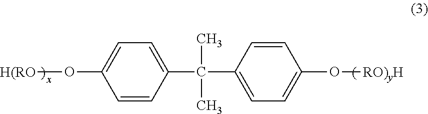

[In the formula, R represents an ethylene group or a propylene group, x and y are each independently an integer of 0 or greater, and the average value of x+y is 1 to 10.]

In addition, polyhydric alcohols, such as glycerin, pentaerythritol, sorbitol, sorbitan, and oxoalkylene ether of a novolak-type phenolic resin, may be mentioned as alcohol components.

Meanwhile, examples of acid components may include a benzenedicarboxylic acid or an anhydride thereof, such as phthalic acid, terephthalic acid, isophthalic anhydride, and phthalic anhydride; and an alkyl dicarboxylic acid or an anhydride thereof, such as succinic acid, adipic acid, sebacic acid, and azelaic acid. Further, succinic acid substituted with a C6-18 alkyl or alkenyl group or an anhydride thereof; and an unsaturated dicarboxylic acid or an anhydride thereof, such as fumaric acid, maleic acid, citraconic acid, or itaconic acid, and the like may be mentioned.

Further, polycarboxylic acids, such as trimellitic acid, pyromellitic acid, 1,2,3,4-butanetetracarboxylic acid, and benzophenonetetracarboxylic acid, and an anhydride thereof may be mentioned. Trimellitic acid and trimellitic anhydride are preferred.

The polyester resin preferably has monomer units derived from an alcohol component and monomer units derived from an acid component. In all the monomer units derived from alcohol components, the content ratio of the monomer units derived from a bisphenol A ethylene oxide adduct is preferably 30 mol % or more.

The polyester resin is preferably a condensation polymerization product of an alcohol component and a carboxylic acid component containing an aliphatic dicarboxylic acid having from 4 to 18 (more preferably from 6 to 12) carbon atoms. The average added mole number of ethylene oxide relative to bisphenol A is preferably from 1.6 to 3.0 moles and more preferably from 1.6 to 2.6 moles.

The molar ratio of the aliphatic dicarboxylic acid having from 4 to 18 carbon atoms to the carboxylic acid components is more preferably from 6 to 40 mol %.

Examples of aliphatic dicarboxylic acids having from 4 to 18 carbon atoms may include alkyl dicarboxylic acids, such as tetradecanedioic acid and octadecanedioic acid, and an anhydride thereof and a lower alkyl ester therefrom. Other examples may include compounds having a structure in which a part of the main chain of those aliphatic dicarboxylic acids is branched with an alkyl group, such as a methyl group, an ethyl group, or an octyl group, or an alkylene group. Alicyclic dicarboxylic acids, such as tetrahydrophthalic acid, may also be mentioned.

Polyester resins can be produced using any catalysts that have been normally used, for example, metals, such as tin, titanium, antimony, manganese, nickel, zinc, lead, iron, magnesium, calcium, and germanium; and compounds containing these metals.

The acid value of the binder resin is preferably 1.0 to 50.0 mgKOH/g and more preferably 4.0 to 35.0 mgKOH/g, from the perspective of uniformly retaining a resin bearing an oxazoline group at the surface of the toner particle.

The hydroxyl value of the binder resin is preferably 0.5 to 20.0 mgKOH/g and more preferably 1.0 to 15.0 mgKOH/g.

The amorphous polyester resin may be a resin mixture of a plurality of amorphous polyester resins with different softening points.

The softening point of the amorphous polyester resin is preferably 80° C. to 180° C., and more preferably 100° C. to 150° C.

### Other Binder Resins

As the binder resin, the following polymers can also be used.

Examples thereof may include homopolymers of styrene and a derivative thereof, such as polystyrene, poly-p-chlorostyrene, and polyvinyl toluene; styrene-based copolymers, such as a styrene-p-chlorostyrene copolymer, a styrene-vinyltoluene copolymer, a styrene-vinylnaphthaline copolymer, a styrene-acrylic acid ester copolymer, a styrene-methacrylic acid ester copolymer, a styrene-a-chloromethyl methacrylate copolymer, a styrene-acrylonitrile copolymer, a styrene-vinyl methyl ether copolymer, a styrene-vinyl ethyl ether copolymer, a styrene-vinyl methyl ketone copolymer, and a styrene-acrylonitrile-indene copolymer; polyvinyl chloride; a phenolic resin; a natural resin-modified phenolic resin; a natural resin-modified maleic acid resin; an acrylic resin; a methacrylic resin; poly(vinyl acetate); a silicone resin; a polyester resin; a polyurethane resin; a polyamide resin; a furan resin; an epoxy resin; a xylene resin; polyvinyl butyral; a terpene resin; a coumarone-indene resin; a petroleum-based resin; and other polymers.

### Wax

In order to impart a releasing property to the toner, a release agent (wax) may be used for the toner particle. Examples of waxes may include the followings: aliphatic hydrocarbon waxes, such as low-molecular-weight polyethylene, low-molecular-weight polypropylene, an olefin copolymer, microcrystalline wax, paraffin wax, and Fischer-Tropsch wax; oxidized waxes of aliphatic hydrocarbon waxes, such as an oxidized polyethylene wax; waxes containing a fatty acid ester as the major ingredient, such as carnauba wax, behenyl behenate, and montan acid ester wax; and partially or completely deoxidized fatty acid esters, such as deoxidized carnauba wax. Furthermore, the following may also be exemplified.

Examples may include saturated linear fatty acids, such as palmitic acid, stearic acid, and montanoic acid; unsaturated fatty acids, such as brassidic acid, eleostearic acid, and parinaric acid; saturated alcohols, such as stearyl alcohol, aralkyl alcohols, behenyl alcohol, carnaubyl alcohol, ceryl alcohol, and myricyl alcohol; polyhydric alcohols, such as sorbitol; fatty acid amides such as linolamide, oleamide, and lauramide; saturated fatty acid bisamides, such as methylene bisstearamide, ethylene biscapramide, ethylene bislauramide, and hexamethylene bisstearamide; unsaturated fatty acid amides, such as ethylene bisoleamide, hexamethylene bisoleamide, N,N′-dioleyl adipamide, and N,N′-dioleyl sebacamide; aromatic bisamides, such as m-xylene bisstearamide, and N,N′-distearyl isophthalamide; fatty acid metal salts (generally known as metal soaps), such as calcium stearate, calcium laurate, zinc stearate, and magnesium stearate; waxes in which an aliphatic hydrocarbon wax is grafted with a vinyl monomer, such as styrene or acrylic acid; partially esterified products resulting from reacting a polyhydric alcohol with a fatty acid, such as behenic acid monoglyceride; methyl ester compounds having a hydroxy group obtained by hydrogenating vegetable oils and fats; and the like.

Waxes containing a fatty acid ester as a major ingredient are preferred, with behenyl behenate being more preferred.

The wax may be added during the production of the toner or during the production of the binder resin. These waxes may be used alone as a single type or in combination with two or more types thereof.

The wax content is preferably from 1 to 20 parts by mass relative to 100 parts by mass of the binder resin.

### Wax Dispersing Agent

In order to improve the dispersibility of the wax in the binder resin, a resin containing both a polar segment close to the wax component and a segment close to the resin polarity may be added as a wax dispersing agent. Specifically, a styrene-acrylic resin graft-modified with a hydrocarbon compound is preferred.

When a cyclic hydrocarbon group or an aromatic ring is introduced into the resin portion of the wax dispersing agent, the charge-maintaining property of the toner is improved.

### Colorant

The toner particle may contain a colorant. Examples of colorants may include the following.

Examples of black colorants may include carbon black; and those color-matched to black using yellow colorants, magenta colorants and cyan colorants. Although the colorant may contain a pigment alone, it is more preferable to use a dye and a pigment in combination to enhance the color definition thereof from the perspective of the image quality of full-color images.

Examples of magenta coloring pigments may include the following. C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282; C.I. Pigment Violet 19; and C.I. Vat Red 1, 2, 10, 13, 15, 23, 29, and 35.

Examples of magenta coloring dyes may include the following. C.I. Solvent Red 1, 3, 8, 23, 24, 25, 27, 30, 49, 81, 82, 83, 84, 100, 109, and 121; C.I. Disperse Red 9; C.I. Solvent Violet 8, 13, 14, 21, and 27; oil-soluble dyes, such as C.I. Disperse Violet 1, and basic dyes, such as C.I. Basic Red 1, 2, 9, 12, 13, 14, 15, 17, 18, 22, 23, 24, 27, 29, 32, 34, 35, 36, 37, 38, 39, and 40; and C.I. Basic Violet 1, 3, 7, 10, 14, 15, 21, 25, 26, 27, and 28.

Examples of cyan coloring pigments may include the following. C.I. Pigment Blue 2, 3, 15:2, 15:3, 15:4, 16, and 17; C.I. Vat Blue 6; C.I. Acid Blue 45, and copper phthalocyanine pigments in which 1 to 5 phthalimide methyl groups are substituted on the phthalocyanine backbone.

Examples of cyan coloring dyes may include C.I. Solvent Blue 70.

Examples of yellow coloring pigments may include the following. C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185; and C.I. Vat Yellow 1, 3, and 20.

Examples of yellow coloring dyes may include C.I. Solvent Yellow 162.

The amount of the colorant used is preferably from 0.1 to 30 parts by mass relative to 100 parts by mass of the binder resin.

### Charge Control Agent

The toner particle may optionally contain a charge control agent.

Examples of known charge control agents may include an azo iron compound, an azo chromium compound, an azo manganese compound, an azo cobalt compound, an azo zirconium compound, a chromium compound of a carboxylic acid derivative, a zinc compound of a carboxylic acid derivative, an aluminum compound of a carboxylic acid derivative, and a zirconium compound of a carboxylic acid derivative. The carboxylic acid derivative is preferably an aromatic hydroxycarboxylic acid. A charge control resin may also be used. One or two or more types of charge control agents may be used in combination as needed.

The charge control agent is preferably added in an amount from 0.1 to 10 parts by mass relative to 100 parts by mass of the binder resin.

### Crystalline Polyester

The toner particle may optionally contain a crystalline polyester.

The crystalline polyester content is preferably from 0.5 to 20 parts by mass relative to 100 parts by mass of the binder resin.

Examples of alcohol components to be used as raw material monomers for crystalline polyesters may include, but not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-icosanediol, and the like.

The aliphatic diol content is preferably from 80 to 100 mol % in the alcohol component from the perspective of further enhancing the crystallinity of the crystalline polyester.

The alcohol component for obtaining the crystalline polyester may contain a polyhydric alcohol component other than the aliphatic diols mentioned above.

For example, aromatic diols, such as bisphenol A alkylene oxide adducts, including a 2,2-bis(4-hydroxyphenyl) propane polyoxypropylene adduct and a 2,2-bis(4-hydroxyphenyl) propane polyoxyethylene adducts; and tri- or further polyhydric alcohols, such as glycerin, pentaerythritol, and trimethylolpropane, may be mentioned.

Meanwhile, examples of carboxylic acid components to be used as raw material monomers for the crystalline polyester mentioned above may include aliphatic dicarboxylic acids, such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid, as well as an anhydride thereof and a lower alkyl ester therefrom.

The aliphatic dicarboxylic acid content is preferably from 80 to 100 mol % in the carboxylic acid components.

The carboxylic acid component for obtaining the crystalline polyester may contain a carboxylic acid component other than the aliphatic dicarboxylic acid compounds mentioned above. For example, aromatic dicarboxylic acid compounds and aromatic polycarboxylic acid compounds with three or more carboxy groups may be mentioned, although not particularly limited thereto. The aromatic dicarboxylic acid compounds also include aromatic dicarboxylic acid derivatives.

Specific preferable examples of aromatic dicarboxylic acid compounds may include aromatic dicarboxylic acids, such as phthalic acid, isophthalic acid, terephthalic acid, and naphthalene-2,6-dicarboxylic acid, as well as an anhydride thereof, and an alkyl (having from 1 to 3 carbon atoms) ester therefrom. Examples of alkyl groups in the alkyl ester may include a methyl group, an ethyl group, a propyl group, and an isopropyl group.

Examples of polycarboxylic acid compounds having three or more carboxy groups may include aromatic carboxylic acids, such as 1,2,4-benzenetricarboxylic acid (trimellitic acid), 2,5,7-naphthalenetricarboxylic acid, and pyromellitic acid, and an anhydride thereof, and derivatives, such as an alkyl (having from 1 to 3 carbon atoms) ester.

The molar ratio (carboxylic acid component/alcohol component) between the alcohol components and the carboxylic acid components, which are raw material monomers of the crystalline polyester, is preferably from 0.80 to 1.20.

### External Additive

If necessary, an external additive may be added to the toner particle in order to improve the flowability and adjust the triboelectric charge quantity.

As the external additive, inorganic fine particles, such as silica, titanium dioxide, aluminum oxide, and strontium titanate, are preferable. The inorganic fine particle is preferably subjected to a hydrophobic treatment with a hydrophobic agent, such as a silane compound, a silicone oil, or a mixture thereof.

The external additive preferably has a BET specific surface area from 10 m²/g to 50 m²/g from the perspective of suppressing the embedding of the external additive.

The external additive is preferably used in an amount from 0.1 to 5.0 parts by mass relative to 100 parts by mass of the toner particle.

The toner particle and the external additive may be mixed using a known mixer, such as a Henschel mixer. However, it is acceptable if mixing is possible, and there are no particular limitations on the device.

### Production Method of Toner

The production method of the toner is not particularly limited, and a known production method may be used. For example, a pulverization method, an emulsion aggregation method, a suspension polymerization method, a dissolution suspension method, or the like may be mentioned. Further, the production method of the toner preferably includes a step of producing the toner particle.

### Production Method of Toner Particle

Production method of the toner particle will be described with reference to an example of a production method of a toner using a pulverization method.

In the raw material mixing step, materials that constitute the toner particle, such as the binder resin and, if necessary, other components like a wax, a colorant, and a charge control agent, are weighed in predetermined amounts, blended, and mixed. Examples of mixing devices may include a double cone mixer, a V-type mixer, a drum-type mixer, Super Mixer, a Henschel mixer, a Nauta mixer, Mechano Hybrid (manufactured by Nippon Coke & Engineering Co., Ltd.), and the like.

Next, the mixed materials are melt-kneaded and then dispersed in a binder resin. In the melt-kneading step, a batch-type kneader, such as a pressure kneader or a Banbury mixer, or a continuous-type kneader can be used, and single-screw or twin-screw extruders are the mainstream due to the advantage in continuous production. Examples thereof may include a KTK-type twin-screw extruder (manufactured by Kobe Steel, Ltd.), a TEM-type twin-screw extruder (manufactured by Toshiba Machine Co., Ltd.), a PCM kneader (manufactured by Ikegai Corporation), a twin-screw extruder (manufactured by KCK Corporation), a Co-Kneader (manufactured by Buss AG), and KNEADEX (manufactured by Nippon Coke & Engineering Co., Ltd.). In addition, the kneaded product obtained by melt-kneading may be rolled with a two-roll mill or the like and cooled with water in a cooling step.

Next, the cooled kneaded product is pulverized to a desired particle diameter in the pulverizing step. In the pulverizing step, for example, after coarsely pulverizing the cooled kneaded product in a pulverizer, such as a crusher, a hammer mill, or a feathermill, and additionally, the coarsely pulverized matter is finely pulverized by, for example, Cryptotron system (manufactured by Kawasaki Heavy Industries, Ltd.), Super Rotor (manufactured by Nisshin Engineering Inc.), Turbo mill (manufactured by Turbo Industry Co., Ltd.), or an air jet-type fine pulverizer.

Then, as necessary, classification is performed using a classifier or a sieving machine, such as Elbow Jet (manufactured by Nittetsu Mining Co., Ltd.), which uses an internal classification system, Turboplex (manufactured by Hosokawa Micron Corporation), which uses a centrifugal classification system, TSP separator (manufactured by Hosokawa Micron Corporation), or Faculty (manufactured by Hosokawa Micron Corporation), to obtain a toner particle.

The step of adding a resin bearing an oxazoline group to the particle surface of the toner particle is not particularly limited, and a known method is used, and it is preferred to add the resin in a step of adding a resin bearing an oxazoline group in a medium, such as water. The resin bearing an oxazoline group has good solubility in a medium, such as water.

More specifically, a toner particle and a resin bearing an oxazoline group are added to an aqueous medium, and materials are mixed and dispersed in an aqueous medium, whereby the resin bearing an oxazoline group is incorporated onto the particle surface of the toner particle.

Examples of methods of effectively dispersing the toner particle in a dispersion may include a method involving mechanically dispersing the toner particle using a device capable of strongly agitating the dispersion, and a method involving dispersing the toner particle in an aqueous medium containing a dispersing agent. The above methods are effective because the toner particle is uniformly dispersed in the aqueous medium.

As a device capable of strongly agitating the dispersion, Hibismix (Primix Co., Ltd.) may be mentioned, for example.

When the toner particle is dispersed in the aqueous medium, a dispersing agent may be used. Examples of dispersing agents may include sodium polyacrylate, poly (p-vinylphenol), partially saponified polyvinyl acetate, isoprene sulfonic acid, polyether, an isobutylene/maleic anhydride copolymer, sodium polyaspartate, starch, gelatin, gum arabic, polyvinylpyrrolidone, sodium lignosulfonate, and the like. These may be used singly, or in combination of two or more types thereof.

The dispersing agent is preferably used in an amount of 75 parts by mass or less relative to 100 parts by mass of the toner particle. When the amount of the dispersing agent used falls within the above range, the total organic carbon content in the wastewater can be reduced.

In the above step, it is preferred to adjust the pH of the aqueous dispersion containing the toner particle to about 4. For example, the pH is preferably 3 to 5.

During the above step, the temperature when the resin bearing an oxazoline group is adhered to the surface of the toner particle is preferably from 55° C. to 100° C.

When the binder resin contains a polyester resin bearing a carboxy group, a carboxy group exposed at the surface of the toner particle can be effectively reacted with an oxazoline group by setting the temperature within the above range.

As a result, covalent bonds are formed between the binder resin constituting the toner particle and the resin bearing an oxazoline group, whereby the toner particle and the resin bearing an oxazoline group can be firmly adhered to each other.

Further, opening of the ring of the oxazoline group may be facilitated by adding a ring-opening agent (for example, an acidic aqueous solution, such as an aqueous acetic acid solution).

A dispersion of the toner particle is obtained by cooling an aqueous dispersion containing the toner particle containing a resin bearing an oxazoline group to an ordinary temperature. Subsequently, the toner particle is obtained from the toner particle dispersion by undergoing washing and drying steps as needed.

In the cleaning step, the toner particle is washed with water. One example of a washing method involves recovering a toner particle from an aqueous dispersion containing the toner particle as a wet cake containing the toner particle by solid-liquid separation and washing the obtained wet cake with water. An alternative method involves settling a toner particle in a dispersion containing the toner particle, replacing the supernatant with water, and then redispersing the toner particle in the water after replacement.

The washing step enables organic components contained in the dispersing agent to be removed because the dispersing agent in the toner is removed.

In the drying step, a drying apparatus, such as a spray dryer, a fluidized bed dryer, a vacuum freeze-dryer, or a vacuum dryer is used to dry the toner particle after recovery or washing. The use of a spray dryer can restrain the aggregation of the toner particle during drying.

The toner particle obtained may be used as it is as a toner. If necessary, a selected external additive, such as inorganic fine powder and resin particles, may be added to the toner particle and mixed (externally added) to obtain the toner. An external additive enables imparting flowability and improving charging stability.

The mixing apparatus includes a rotating member equipped with stirring members and a mixing device equipped with a main body casing provided with a gap between the stirring members and the casing.

Examples of such mixing apparatuses may include a Henschel mixer (manufactured by Mitsui Mining Co., Ltd.); SUPERMIXER (manufactured by Kawata Mfg. Co., Ltd.); RIBOCONE (manufactured by Okawara Mfg. Co., Ltd.); Nauta Mixer, Turbulizer, Cyclomix (manufactured by Hosokawa Micron Corporation); Spiral Pin Mixer (manufactured by Pacific Machinery & Engineering Co., Ltd.); Loedige mixer (manufactured by MATSUBO Corporation); Nobilta (manufactured by Hosokawa Micron Corporation); and the like. In particular, to uniformly mix and loosen silica aggregates, a Henschel mixer (manufactured by Mitsui Mining Co., Ltd.) is preferably used.

Examples of device conditions for mixing may include throughput, the number of revolutions of a stirring shaft, stirring time, the shape of a stirring blade, and intra-tank temperature. The device conditions are selected, as appropriate, in consideration of the various physical properties of the toner particle and the type of additives in order to achieve the desired toner performance, and are not particularly limited.

Furthermore, if, for example, coarse aggregates of additives are present in a free state in the obtained toner, a sieve may be used as necessary.

### Developer

The carrier mixing ratio of the two-component developer of the present disclosure, expressed as the toner concentration within the two-component developer, typically yields good results when set to preferably from 2 to 15 mass % and more preferably from 4 to 13 mass %.

The measurement method of various physical properties will be described below.

### Measurement Method of Acid Value

An acid value is the number of milligrams of potassium hydroxide required to neutralize an acid contained in 1 gram of a sample. The acid value is measured according to JIS K 0070-1992, and specifically, according to the following procedure.

### (1) Preparation of Reagent

1.0 g of phenolphthalein is dissolved in 90 mL of ethyl alcohol (95 vol %), deionized water is added to adjust the volume to 100 mL, thereby preparing a phenolphthalein solution.

7 g of special-grade potassium hydroxide is dissolved in 5 mL of water, and ethyl alcohol (95 vol %) is added to adjust the volume to 1 L. In order to prevent contact with carbon dioxide gas and the like, the mixture is put into an alkali-resistant container, left for 3 days, and then filtered to obtain a potassium hydroxide solution. The obtained potassium hydroxide solution is stored in an alkali-resistant container. The factor of the potassium hydroxide solution is determined from the amount of the potassium hydroxide solution required for neutralization when 25 mL of 0.1 mol/L hydrochloric acid is put into an Erlenmeyer flask, several drops of a phenolphthalein solution are added, and titration with the potassium hydroxide solution is performed. 0.1 mol/L hydrochloric acid prepared according to JIS K 8001-1998 is used.

### (2) Operation

### (A) Main Test

2.0 g of a pulverized sample is weighed exactly into a 200 mL Erlenmeyer flask, 100 mL of a mixed solution of toluene/ethanol (2:1) is added thereto, and the mixture is dissolved over 5 hours. Next, several drops of a phenolphthalein solution are added as an indicator, and the titration is performed with a potassium hydroxide solution. Here, the titration endpoint is when the indicator turns light red and remains so for about 30 seconds.

### (B) Blank Test

The titration is performed by the same operation as above, except that no sample is used (that is, only a mixed solution of toluene/ethanol (2:1) is used).

(3) The obtained result is substituted into the following formula to calculate the acid value.

$$A = [ ( C - B ) \times f \times 5.61 ] / S$$

wherein A: acid value (mgKOH/g), B: amount of the potassium hydroxide solution added in the blank test (mL), C: amount of the potassium hydroxide solution added in the main test (mL), f: factor of the potassium hydroxide solution, S: mass of the sample (g).

### Measurement Method of Softening Point of Resin

The softening point is measured using a constant-load extrusion-type capillary rheometer, the “flow characteristic evaluation device Flowtester CFT-500D” (manufactured by Shimadzu Corporation), according to the instructions in the manual bundled with the apparatus.

In this device, a constant load is applied from above the measurement sample using a piston, the measurement sample that is filled in a cylinder is heated to melt, the molten measurement sample is extruded from a die at the bottom of the cylinder, and a flow curve showing the relationship between the amount of piston drop and the temperature in this case can be obtained.

In the present disclosure, the “melting temperature in the 1/2 method” described in the manual bundled in the “flow characteristic evaluation device Flowtester CFT-500D” is defined as the softening point.

Here, the melting temperature in the 1/2 method is calculated as follows.

First, a half of the difference between the amount of piston drop Smax when the outflow ends and the amount of piston drop Smin when the outflow starts is calculated (this is referred to as X; X=(Smax−Smin)/2). Then, the temperature on the flow curve when the amount of piston drop is the sum of X and Smin is the melting temperature in the 1/2 method.

A measurement sample is obtained by compression-molding about 1.0 g of the resin under an environment of 25° C. using a tablet press (for example, NT-100H, manufactured by NPa System Co., Ltd.) at about 10 MPa for about 60 seconds to form a cylindrical shape with a diameter of approximately 8 mm.

The measurement conditions for CFT-500D are as follows.
Test mode: Temperature-rising method
Start temperature: 40° C.
Saturated temperature: 200° C.
Measurement interval: 1.0° C.
Ramp rate: 4.0° C./min
Piston cross-sectional area: 1.000 cm²
Test load (piston load): 10.0 kgf/cm² (0.9807 MPa)
Preheating time: 300 seconds
Diameter of hole of die: 1.0 mm
Length of die: 1.0 mm

### Measurement Method of Weight-Average Particle Diameter (D4) of Toner Particle

The weight-average particle diameter (D4) of the toner particle (or toner core particle) is calculated by measuring 25000 channels as the number of effective measurement channels and analyzing measurement data using a precision particle size distribution measurement device, “Coulter counter Multisizer 3” (registered trademark, manufactured by Beckman Coulter, Inc.), which includes a 100 μm aperture tube and is measured based on a pore electrical resistance method, and a dedicated bundled software, “Beckman Coulter Multisizer 3 Version 3.51” (manufactured by Beckman Coulter, Inc.) for setting the measurement conditions and analyzing measurement data.

As an aqueous electrolyte solution used for the measurement, a solution prepared by dissolving special-grade sodium chloride in deionized water to a concentration of about 1 mass %, for example, “ISOTON II” (manufactured by Beckman Coulter, Inc.) can be used.

Before the measurement and the analysis, the dedicated software is set as follows. In the “Change Standard Measurement Method (SOM) Screen” in the dedicated software, the total count in the control mode is set to 50000 particles, the number of measurements is set to 1, and the Kd value is set to a value obtained using “standard particles 10.0 μm” (manufactured by Beckman Coulter, Inc.). When the threshold/noise level measurement button is pressed, the threshold and the noise level are automatically set. In addition, the current is set to 1600 μA, the gain is set to 2, the electrolyte solution is set to ISOTON II, and the box “flush aperture tube after measurement” is checked.

In the “Pulse to Particle Size Conversion Settings Screen” in the dedicated software, the bin interval is set to the logarithmic particle diameter, the particle diameter bin to 256 particle diameter bin, and the particle diameter range to from 2 μm to 60 μm.

A specific measurement method is as described below.

(1) About 200 mL of the aqueous electrolytic solution mentioned above is put in a 250 mL round-bottomed glass beaker dedicated to Multisizer 3, the beaker is placed on a sample stand, and the contents are stirred counterclockwise using a stirrer rod at 24 revolutions per second. Then, contaminants and air bubbles in the aperture tube are removed by the function “Flush Aperture Tube” in the dedicated software.

(2) About 30 mL of the electrolytic aqueous solution is put in a 100 mL flat-bottom glass beaker, and about 0.3 mL of the diluent described below is added to the beaker as a dispersing agent.
Diluent: a diluted solution containing “Contaminon N” (a 10 mass % aqueous solution of a neutral detergent with pH 7 for washing precision measurement instruments, containing a nonionic surfactant, an anionic surfactant, and an organic builder, manufactured by Wako Pure Chemical Industries, Ltd.), diluted with deionized water 3 times by mass

(3) A predetermined amount of deionized water is put in a water tank of the following ultrasonic disperser with two built-in oscillators with an oscillating frequency of 50 kHz and with phases shifted by 180 degrees, exhibiting an electrical output of 120 W, and about 2 mL of Contaminon N described above is added to this water tank.
Ultrasonic disperser: “Ultrasonic Dispersion System Tetora 150” (manufactured by Nikkaki Bios Co., Ltd.)

(4) The beaker in (2) is placed in a beaker-fixing hole of the ultrasonic disperser, and the ultrasonic disperser is activated. Then, the height position of the beaker is adjusted so that the resonance state of the liquid level of the aqueous electrolyte solution in the beaker is maximized.

(5) In a state where the aqueous electrolyte solution in the beaker in (4) has been irradiated with ultrasonic waves, about 10 mg of the toner particle is added little by little to the aqueous electrolyte solution and dispersed. Then, the ultrasonic dispersion treatment is continued for an additional 60 seconds. For ultrasonic dispersion, the water temperature in the water tank is adjusted, as appropriate, to be within the range from 15° C. to 40° C.

(6) Into the round-bottom beaker in (1) placed in the sample stand, the aqueous electrolyte solution in (5), in which the toner is dispersed, is added dropwise using a pipette, and the measurement concentration is adjusted to 5%. Then, measurements are performed until the number of measurement particles reaches 50000.

(7) The measurement data are analyzed with the dedicated software bundled with the apparatus, and the weight-average particle diameter (D4) is calculated. The weight-average particle diameter (D4) is the “average diameter” on the analysis/volume statistical value (arithmetic average) screen when graph/% by volume is set in the dedicated software.

### EXAMPLES

The basic configuration and features of the present disclosure have been described as above, and the present disclosure will be described below in detail with reference to the Examples. However, the present disclosure is not limited thereto. Here, unless otherwise specified, parts and % are based on mass.

### Production Example of Binder Resin 1

Bisphenol A propylene oxide (2.2 mol adduct): 71.3 parts
Terephthalic acid: 24.1 parts
Titanium tetrabutoxide: 0.6 parts

The above materials were placed in a 4-liter four-necked glass flask. A thermometer, a stirring bar, a condenser, and a nitrogen inlet tube were attached to the flask, and the flask was placed in a mantle heater. Next, the inside of the flask was purged with nitrogen gas, the temperature was then gradually raised under stirring, and the reaction was allowed to proceed for 2 hours, while stirring at a temperature of 200° C. (first reaction step).

Then, 5.0 parts of trimellitic anhydride was added and allowed to react at 180° C. for 10 hours (second reaction step) to obtain a binder resin 1.

The binder resin 1 had an acid value of 10.5 mgKOH/g and a softening point of 130° C.

### Production Examples of Binder Resins 2 and 3

Binder resins 2 to 3 were obtained in the same manner as in the case of the binder resin 1, except that the amount of trimellitic anhydride added was adjusted such that the acid value of the binder resin be a value shown in Table 1.

### Production Example of Toner 1

### Production Example of Toner Particle

Binder resin 1:100.0 parts
Behenyl behenate (melting point: 72° C.): 4.0 parts
C.I. pigment Blue 15:35.0 parts
Aluminum 3,5-di-tert-butylsalicylate compound: 0.5 parts

The raw materials shown as the above formulation were mixed using a Henschel mixer (FM-75 model, manufactured by Nippon Coke & Engineering Co., Ltd.) at the number of revolutions of 20 s⁻¹ for a rotational time of 5 min, and were then kneaded in a two-screw kneader (PCM-30 model, manufactured by Ikegai Corporation) set at a temperature of 125° C. The resulting kneaded product was cooled and coarsely pulverized to 1 mm or less using a hammer mill, thereby yielding a coarsely pulverized product. The resulting coarsely pulverized product was finely pulverized using a mechanical pulverizer (T-250, manufactured by Freund-Turbo Corporation).

Further, classification was performed using a rotary classifier (200TSP, manufactured by Hosokawa Micron Corporation) to obtain a toner core. Classification was carried out under the operating condition of a rotary classifier (200TSP, manufactured by Hosokawa Micron Corporation) at the number of revolutions of the classification rotor of 50.0 s⁻¹. The toner core thus obtained had a weight-average particle diameter (D4) of 5.9 μm.

Then, a 1-liter three-necked flask equipped with a thermometer and stirring blades was prepared, and the flask was placed in a water bath. Subsequently, 300 mL of deionized water was put in a flask, and the temperature in the flask was kept at 30° C. using a water bath. Subsequently, dilute hydrochloric acid was added to the flask to adjust the pH of the flask contents to 4.

Subsequently, 90 g of an aqueous solution of a resin bearing an oxazoline group (“EPOCROS (registered trademark) WS-300” manufactured by Nippon Shokubai Co., Ltd., solids concentration: 10 mass %) was put in a flask.

Subsequently, 300 g of the toner particle were added to the flask, and the flask contents were sufficiently stirred. Subsequently, 300 mL of deionized water was further added to the flask, and the temperature in the flask was raised to 65° C. at a rate of 1° C./min while stirring the flask contents. Then, 30 g of an aqueous acetic acid solution (concentration: 1%) was added as a ring-opening agent, and then the flask contents were stirred at a temperature of 60° C. for 2 hours. As a result, a dispersion of a toner particle containing a resin bearing an oxazoline group at the particle surface in a liquid was obtained.

Subsequently, the pH of the toner particle dispersion was adjusted (neutralized) to 7 with sodium hydroxide, and the toner particle dispersion was cooled to an ordinary temperature (about 25° C.).

The dispersion of the toner particle obtained as described above was filtered (solid-liquid separated) using a Buchner funnel. As a result, a toner particle in the form of a wet cake was obtained. Thereafter, the wet cake-form toner particle thus obtained were re-dispersed in deionized water. Further, dispersion and filtration were repeated five times to wash the toner particle.

Subsequently, the washed wet cake-form toner particle was put in a vacuum shelf dryer, and dried for 24 hours under the conditions of a degree of vacuum of 1 kPa and a temperature of 40° C. As a result, a dried toner particle (powder) was obtained.

### External Addition Step

To 100 parts of the toner particle obtained, 0.8 parts of dry silica particles surface-modified with a trimethylsilyl group and an amino group was added, and the mixture was mixed at a number of revolutions of 30 s⁻¹ for a rotational time of 10 min using a Henschel mixer (FM-75 model, manufactured by Mitsui Mining Co., Ltd.), followed by sieving with a 150-μm mesh to prepare a toner 1.

The oxazoline group content ratio in the toner 1 was 20 μmol/g, and the value (Y/X) of the ratio in an FT-IR spectrum measured using the ATR method was 0.21. Production Examples of Toners 2 and 5

Toners 2 to 5 were obtained in the same manner as in the case of the toner 1, except that the binder resin No., the addition amount of an aqueous solution of the resin bearing an oxazoline group, and the addition amount of acetic acid were changed as shown in Table 1. Physical properties of the obtained toner are shown in Table 1.

TABLE 1

| | | Acid value | Aqueous solution of resin | | Content ratio of oxazoline | |
|---|---|---|---|---|---|---|
| Toner No. | Binder resin No. | (mgKOH/g) | bearing an oxazoline group (g) | Acetic acid (g) | groups (μmol/g) | Value (Y/X) of ratio |
| Toner 1 | Binder resin 1 | 10.5 | 90 | 30 | 20 | 0.21 |
| Toner 2 | Binder resin 1 | 10.5 | 210 | 120 | 50 | 0.18 |
| Toner 3 | Binder resin 2 | 25 | 15 | 15 | 0.2 | 0.16 |
| Toner 4 | Binder resin 3 | 5 | 330 | 60 | 100 | 0.24 |
| Toner 5 | Binder resin 3 | 5 | 390 | 0 | 125 | 0.31 |

### Production Example of Magnetic Carrier

### Production Example of Magnetic Carrier Core Particle 1

Fe₂O₃: 60.0 parts
MnCO₃: 23.0 parts
MgFe₂O₄: 16.4 parts
ZrO₂: 0.6 parts

A ferrite raw material was weighed such that the above materials would be in the above composition ratio.

After that, the raw materials were then pulverized and mixed for 5 hours using a dry vibration mill with stainless steel beads. The obtained pulverized material was formed into pellets of about 1 mm square using a roller compactor.

The coarse powder was removed from the pellets through a vibrating sieve with a 3 mm aperture, and the fine powder was removed through a vibrating sieve with a 0.5 mm aperture. After that, the powder was fired at 1000° C. for 4 hours under a nitrogen atmosphere (oxygen concentration: 0.01 vol %) using a burner-type furnace, thereby preparing calcined ferrite.

After the calcined ferrite was pulverized to about 0.3 mm by a crusher, 30 parts of water was added relative to 100 parts of the calcined ferrite using zirconia beads, then pulverized by a wet ball mill for 1 hour. The resulting slurry was pulverized by a wet ball mill for 4 hours, thereby preparing a ferrite slurry (finely pulverized calcined ferrite).

To the ferrite slurry, 1.0 part of ammonium polycarboxylate as a dispersing agent and 2.0 parts of polyvinyl alcohol as a binder were added relative to 100 parts of the calcined ferrite, and spherical particles were granulated by means of a spray drier (manufacturer: Okawara Kakoki, Co., Ltd.). The particle size of the obtained particles was adjusted, and the particles were heated at 650° C. for 2 hours using a rotary kiln to remove the organic components of the dispersing agent and the binder.

In order to control the firing atmosphere, the temperature was raised from room temperature to a temperature of 1300° C. within 2 hours in an electric furnace under a nitrogen atmosphere (oxygen concentration: 1.00 vol %), and the particle was fired at a temperature of 1150° C. for 4 hours. After that, the temperature was lowered to 60° C. over 4 hours, the atmosphere was returned from the nitrogen atmosphere to ambient air, and the sample was removed at a temperature of 40° C. or lower.

After the aggregated particles were disintegrated, the low magnetic material was cut by magnetic sorting, and the coarse particles were removed by sieving with a sieve having an aperture of 250 μm, to obtain a magnetic carrier core particle 1 having a 50% grain size (D50) of 37.0 μm based on a volume distribution.

### Production Examples of Magnetic Carrier Core Particles 2 to 6

Magnetic carrier core particles 2 to 6 were obtained in the same manner as in the case of the magnetic carrier core particle 1, except that the weight value of the ferrite raw material was changed, as shown in Table 2.

TABLE 2

| Magnetic carrier core | Fe₂O₃ | MnCO₃ | MgFe₂O₄ | ZrO₂ |
|---|---|---|---|---|
| particle No. | (Parts) | (Parts) | (Parts) | (Parts) |
| Magnetic carrier core particle 1 | 60.0 | 23.0 | 16.4 | 0.6 |
| Magnetic carrier core particle 2 | 60.0 | 23.0 | 16.0 | 1.0 |
| Magnetic carrier core particle 3 | 60.0 | 23.0 | 16.9 | 0.1 |
| Magnetic carrier core particle 4 | 60.0 | 23.0 | 15.8 | 1.2 |
| Magnetic carrier core particle 5 | 60.0 | 23.0 | 16.96 | 0.04 |
| Magnetic carrier core particle 6 | 60.0 | 23.0 | 17.0 | 0.0 |

### Production Example of Magnetic Carrier 1

As the resin coating process, a thermosetting silicone resin solution (methyl phenyl silicone resin, solids concentration: 50 mass %, KR-255 (manufactured by Shin-Etsu Chemical Co., Ltd.)), a titanium compound, and barium titanate particles were added as shown in Table 3, and the coating resin solution diluted with 200 parts of toluene was coated on the magnetic carrier core particle 1 using a coating apparatus that is provided with a rotating bottom plate disc and stirring blades within a fluidized bed and performs coating, while forming a swirling flow, so that the coating resin amount be 2.5 parts relative to 100 parts of the magnetic carrier core particle. The resin solution was sprayed in the direction perpendicular to the direction of movement of the fluidized bed within the apparatus.

Then, the resulting carrier was dried at a temperature of 280° C. for 1 hour in a fluidized bed to remove the solvent, thereby preparing a magnetic carrier 1.

The resulting magnetic carrier 1 had a barium titanate particle content in the resin coat layer of 15 mass %, the value (Ti/Ba) of the ratio of the abundance ratio (atomic %) of titanium elements to the abundance ratio (atomic %) of barium elements in an elemental analysis on the magnetic carrier particle surface by X-ray photoelectron spectroscopy was 9.5, the proportion of Ba elements was 0.04 atomic %, and the zirconium oxide content (as oxide equivalent) in fluorescent X-ray analysis was 0.4 mass %.

### Production Example of Magnetic Carriers 2 to 11

Magnetic carriers 2 to 11 were prepared in the same manner as in the case of the magnetic carrier 1, except that magnetic carrier core particles, the type and addition amount of titanium compounds, the particle diameter and the addition amount of the barium titanate particles, and the coating resin amount were changed as shown in Table 3. The analysis results of magnetic carrier are shown in Table 4.

TABLE 3

| | | Amount of | | Amount of | Number-average | | Coating |
|---|---|---|---|---|---|---|---|
| | | silicone resin | | titanium | particle diameter of | Amount of barium | resin |
| Magnetic | Magnetic carrier | solution added | | compound | barium titanate | titanate particle | amount |
| carrier No. | core particle No. | (parts) | Titanium compound | added (parts) | particles (nm) | added (parts) | (parts) |
| Magnetic | Magnetic carrier | 100 | Tetrabutyl titanate | 3.0 | 300 | 18 | 2.5 |
| carrier 1 | core particle 1 | | | | | | |
| Magnetic | Magnetic carrier | 100 | Tetrabutyl titanate | 2.9 | 300 | 12 | 1.5 |
| carrier 2 | core particle 1 | | | | | | |
| Magnetic | Magnetic carrier | 100 | Tetrabutyl titanate | 2.7 | 400 | 25 | 0.8 |
| carrier 3 | core particle 1 | | | | | | |
| Magnetic | Magnetic carrier | 100 | Tetrabutyl titanate | 3.6 | 200 | 12 | 2.5 |
| carrier 4 | core particle 1 | | | | | | |
| Magnetic | Magnetic carrier | 100 | Isopropyl triisostearoyl | 2.8 | 100 | 40 | 1.0 |
| carrier 5 | core particle 2 | | titanate | | | | |
| Magnetic | Magnetic carrier | 100 | Isopropyl triisostearoyl | 2.9 | 500 | 4 | 2.0 |
| carrier 6 | core particle 3 | | titanate | | | | |
| Magnetic | Magnetic carrier | 100 | Diisopropoxy titanium | 1.0 | 600 | 50 | 3.0 |
| carrier 7 | core particle 4 | | bis(ethylacetoacetate) | | | | |
| Magnetic | Magnetic carrier | 100 | Diisopropoxy titanium | 1.8 | 50 | 2 | 2.0 |
| carrier 8 | core particle 5 | | bis(ethylacetoacetate) | | | | |
| Magnetic | Magnetic carrier | 100 | Titanium | 0.0 | 50 | 55 | 2.0 |
| carrier 9 | core particle 6 | | tetra(acetylacetonate) | | | | |
| Magnetic | Magnetic carrier | 100 | Titanium | 0.0 | 50 | 1 | 2.0 |
| carrier 10 | core particle 6 | | tetra(acetylacetonate) | | | | |
| Magnetic | Magnetic carrier | 100 | Titanium | 0.0 | 50 | 0 | 2.0 |
| carrier 11 | core particle 6 | | tetra(acetylacetonate) | | | | |

In the table, the following barium titanate particles were used.
Number-average particle diameter: 200 to 600 nm: BT Series manufactured by Sakai Chemical Industry Co., Ltd.
Number-average particle diameter: 50 to 100 nm: Manufactured by Toda Kogyo Corporation

TABLE 4

| | Barium | | | |
|---|---|---|---|---|
| | titanate | | Zirconium | |
| | particle | | oxide | Ba |
| | content | | content | elements |
| Magnetic carrier No. | (mass %) | Ti/Ba | (mass %) | (atomic %) |
| Magnetic carrier 1 | 15 | 9.5 | 0.4 | 0.04 |
| Magnetic carrier 2 | 10 | 7.6 | 0.4 | 0.05 |
| Magnetic carrier 3 | 20 | 6.2 | 0.4 | 0.06 |
| Magnetic carrier 4 | 10 | 15.0 | 0.4 | 0.03 |
| Magnetic carrier 5 | 28 | 5.0 | 0.8 | 0.08 |
| Magnetic carrier 6 | 4 | 17.5 | 0.1 | 0.02 |
| Magnetic carrier 7 | 32 | 2.0 | 1.0 | 0.10 |
| Magnetic carrier 8 | 2 | 20.0 | 0.01 | 0.01 |
| Magnetic carrier 9 | 35 | 1.0 | 0 | 0.12 |
| Magnetic carrier 10 | 1 | — | 0 | 0 |
| Magnetic carrier 11 | 0 | — | 0 | 0 |

### Example 1

### Preparation of Two-Component Developer 1

The toner 1 and magnetic carrier 1 were added so that the toner concentration be 8.0 mass % and mixed at 0.5 s⁻¹ for a rotational time of 5 min using a V-type mixer (V-10 model: Tokuju Corporation) to prepare a two-component developer 1.

### Evaluation

Using the resulting two-component developer 1, the following evaluations were performed in the following image forming apparatus. The two-component developer 1 received an A rating in all evaluations.

### Evaluation Method

As an image forming apparatus, imagePRESS C800 (manufactured by Canon Inc.) was used and modified so that the DC voltage VDC of the developer carrier and the transfer current could be freely set. The two-component developer 1 was introduced into the developing device at the cyan position of the modified machine. The modifications included enabling free adjustment of the fixation temperature, process speed, DC voltage VDC applied to the developer carrier, charging voltage VD applied to the electrostatic latent image bearing member, laser power, and the total discharge current of the charging device.

Image output was evaluated by outputting an FFh image (solid image) with the desired image ratio, then adjusting the VDC, VD, and laser power to achieve the desired toner coverage on the FFh image, followed by the evaluation described below. FFh is a value that represents 256 gradations in hexadecimal. 00 h is the first gradation (white portion) of 256 gradations, and FFh is the 256th gradation (solid portion) of 256 gradations.

### Dot Reproducibility

Paper: GFC-081 (81.0 g/m²) (available from Canon Marketing Japan Inc.)
Toner coverage on paper: 0.40 mg/cm² (adjusted based on the DC voltage VDC of the developer carrier, the charging voltage VD of the electrostatic latent image bearing member, and the laser power)
Test environment: Temperature: 30° C./Humidity: 80% RH
Process speed: 377 mm/sec

Dot reproducibility was evaluated by outputting 30000 sheets with an image print ratio of 1% under the above conditions.

Thereafter, the following evaluation images were output. A halftone image formed by isolated dots on the basis of the top and rear end margin 5 mm and the left and right margins 5 mm was output (dot print percentage: 10%).

In the image, 100 isolated dots were observed at random using a magnifier, and the minor axis and the major axis of each dot were measured to determine the ratio of the major axis to the minor axis (value obtained by dividing the major axis by the minor axis). Then, using the maximum value of the ratio of the major axis to the minor axis of the 100 isolated dots, dot reproducibility was judged according to the following criteria.
A. The maximum value of the ratio of the major axis to the minor axis was smaller than 1.10.
B. The maximum value of the ratio of the major axis to the minor axis was 1.10 or greater and smaller than 1.20.
C. The maximum value of the ratio of the major axis to the minor axis was 1.20 or greater and smaller than 1.30.
D. The maximum value of the ratio of the major axis to the minor axis was 1.30 or greater. Image Streaks
   Paper: GFC-081 (81.0 g/m²) (available from Canon Marketing Japan Inc.)

Toner coverage on paper: 0.40 mg/cm² (FFh image) (adjusted based on the DC voltage VDC of the developer carrier, the charging voltage VD of the electrostatic latent image bearing member, and the laser power)
Image for evaluation: A line chart with an image ratio of 5% on the entire surface of the
A4 paper sheet
Test environment: temperature 30° C., humidity 80% RH
Process speed: 377 mm/see

100000 sheets of evaluation images were output, and the developing performance was evaluated. If development streaks occur, stains in the form of vertical streaks occur on the paper. Visual evaluation of that state was used as an evaluation index for developing performance.
A: No vertical streaks on the paper
B: One to two vertical streaks were formed on the paper
C: Three to four vertical streaks were formed on the paper
D: Five to six vertical streaks were formed on the paper

### Examples 2 to 8 and Comparative Examples 1 to 3

### Preparation of Two-Component Developers 2 to 11 and Evaluation

Two-component developers 2 to 11 were prepared in the same manner as in the case of the two-component developer 1, except that the toners and the magnetic carrier were changed as shown in Table 5.

Subsequently, evaluation was performed in the same manner as in Example 1, except that the two-component developers 2 to 11 were used. The evaluation results are shown in Table 5.

TABLE 5

| | | | | Image streaks | Image | Dot | Dot |
|---|---|---|---|---|---|---|---|
| Example | Two-component | | Magnetic | evaluation | streaks | reproducibility | reproducibility |
| No. | developer No. | Toner No. | carrier No. | value | rank | evaluation value | rank |
| Example 1 | Two-component | Toner 1 | Magnetic | 0 | A | 1.04 | A |
| | developer 1 | | carrier 1 | | | | |
| Example 2 | Two-component | Toner 2 | Magnetic | 0 | A | 1.04 | A |
| | developer 2 | | carrier 2 | | | | |
| Example 3 | Two-component | Toner 3 | Magnetic | 1 | B | 1.07 | A |
| | developer 3 | | carrier 3 | | | | |
| Example 4 | Two-component | Toner 4 | Magnetic | 1 | B | 1.08 | A |
| | developer 4 | | carrier 4 | | | | |
| Example 5 | Two-component | Toner 5 | Magnetic | 2 | B | 1.12 | B |
| | developer 5 | | carrier 5 | | | | |
| Example 6 | Two-component | Toner 5 | Magnetic | 2 | B | 1.12 | B |
| | developer 6 | | carrier 6 | | | | |
| Example 7 | Two-component | Toner 5 | Magnetic | 3 | C | 1.15 | B |
| | developer 7 | | carrier 7 | | | | |
| Example 8 | Two-component | Toner 5 | Magnetic | 3 | C | 1.18 | B |
| | developer 8 | | carrier 8 | | | | |
| Comparative | Two-component | Toner 5 | Magnetic | 4 | C | 1.22 | C |
| Example 1 | developer 9 | | carrier 9 | | | | |
| Comparative | Two-component | Toner 5 | Magnetic | 4 | C | 1.24 | C |
| Example 2 | developer 10 | | carrier 10 | | | | |
| Comparative | Two-component | Toner 5 | Magnetic | 5 | D | 1.34 | D |
| Example 3 | developer 11 | | carrier 11 | | | | |

According to one aspect of the present disclosure, it is possible to provide a two-component developer that can suppress image streaks caused by a decrease in flowability of the two-component developer for a long period of time, even under a high-temperature, high-humidity environment, thereby improving dot reproducibility.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-023954, filed Feb. 18, 2025, which is hereby incorporated by reference herein in its entirety.

What is claimed is:

1. A two-component developer comprising a toner and a magnetic carrier,
the toner comprising a toner particle;
the toner particle comprising:
a binder resin; and
a resin bearing an oxazoline group at a surface of the toner particle,
the magnetic carrier comprising:
a magnetic carrier core particle; and
a resin coat layer formed on a surface of the magnetic carrier core particle,
the resin coat layer comprising:
a silicone resin; and
a barium titanate particle,
wherein a content of the barium titanate particle in the resin coat layer is 2 to 32 mass %, based on a mass of the resin coat layer, and
a value (Ti/Ba) of a ratio of an abundance ratio (atomic %) of titanium elements to an abundance ratio (atomic %) of barium elements, as determined by X-ray photoelectron spectroscopy of a surface of the magnetic carrier, is 2.0 to 20.0.

2. The two-component developer according to claim 1, wherein assuming all elements detected in fluorescent X-ray analysis of the magnetic carrier are present as oxides and a total oxide content is 100 mass %, a proportion of zirconium oxide (ZrO₂) is 0.01 to 1.0 mass %.

3. The two-component developer according to claim 1, wherein an atomic percentage of barium, based on a total content of carbon, nitrogen, oxygen, fluorine, aluminum, silicon, titanium, manganese, iron, strontium, tin, and barium as determined by X-ray photoelectron spectroscopy of the surface of the magnetic carrier, is 0.01 to 0.1 atomic %.

4. The two-component developer according to claim 1, wherein a number-average particle diameter of primary particles of the barium titanate particle is 100 to 500 nm.

5. The two-component developer according to claim 1, wherein a content ratio of oxazoline groups in the toner, measured by pyrolysis-gas chromatograph/mass spectrometry, is 0.1 to 1500 μmol/g.

6. The two-component developer according to claim 1, wherein a resin having a structure represented by formula (1) below or a structure represented by formula (2) below is present at the surface of the toner particle; and
in an FT-IR spectrum of the toner particle measured by ATR method using Ge as ATR crystals at an infrared light incidence angle of 45°, a peak derived from an amide bond included in the structure represented by formula (1) or the structure represented by formula (2) and a peak derived from an oxazoline group are present; and
a value (Y/X) of a ratio of an intensity (Y) of a peak derived from the oxazoline group to an intensity (X) of a peak derived from the amide bond is 0.15 to 0.25: 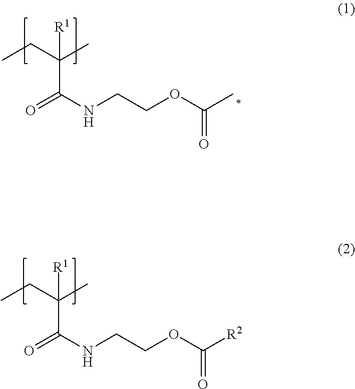
in formula (1), R¹ represents a hydrogen atom or an alkyl group which optionally has a substituent; * represents a connection to a binder resin;
in formula (2), R¹ represents a hydrogen atom or an alkyl group which optionally has a substituent; and R² represents a C1-3 alkyl group.
